(19) United States
(12) Patent Application Publication
(10) Pub. No.: US 2006/0011289 A1
(43) Pub. Date: Jan. 19, 2006

(54) Method of manufacturing composite structural beams for aircraft

(75) Inventor: Carmine Suriano, Foggia (IT)

Correspondence Address: Edward D. Manzo, Esq.;COOK, ALEX, MCFARRON, MANZO,, CUMMINGS & MEHLER, Ltd., 200 West Adams Street, Suite 2850, Chicago, IL, 60606, US

(73) Assignee: Alenia Aeronautica S.p.A.

(21) Appl. No.: 11/154,461

(22) Filed: Jun. 16, 2005

(30) Foreign Application Priority Data
Jun. 21, 2004 (IT) TO2004A000410

(51) Int. Cl. B29C 43/00

(52) U.S. Cl. 156/245; 156/307.1

(57) ABSTRACT

For the manufacturing of a beam of composite material based on carbon fibre, a support plane is overlain with a plurality of mats of carbon fibre pre-impregnated with resin so as to obtain at least one flat laminate. Then at least one edge of the flat laminate is cut at a pre-determined cut angle different from 90° with respect to the support plane. Then the flat laminate is placed on a shaping tool. Then the laminate is hot shaped so as to copy the shape of the shaping tool bending at least one part of the laminate delimited by the cut edge in such a way that the cut edge defines, at the end of the bending phase, a surface orientated perpendicularly with respect to the bent part. Finally temperature and pressure is applied in such a way as to polymerise the resin contained in the layers of matting.

The present invention relates to a method of manufacturing beams of composite material based on carbon fibre for the construction of aircraft.

In the aircraft construction field, until now, the method used for the fabrication of structural elements of the said type has comprised the lamination or deposition of carbon fibre matting pre-impregnated with resin in a mould. The mats are over size with respect to the final dimensions of the beam to be formed. After a polymerisation phase in an autoclave a beam is obtained the edges of which must subsequently be trimmed by means of a cutter. The cut edges must then be re-covered by securing a fabric or cladding of glass fibre with an adhesive for preventing the cut edges from being able to initiate corrosion phenomena, particularly because of the moisture in the presence of low temperatures.

In many applications in the aeronautical field, for structural reasons it is required that the web of the beam should have some locally thickened reinforcement regions. To achieve these reinforcements doublers are fabricated separately by means of lamination of carbon fibres pre-impregnated with resin. These reinforcements are polymerised separately and then cut to shape with a mill, thus obtaining a series of doublers (for example of flattened frusto-pyramid form) which are finally secured by means of adhesive onto one or both sides of the web of the beam.

The present invention seeks to achieve the object of providing a method of manufacturing elongate structural elements of the type specified above, mainly addressing the problem of reducing the time, cost and the number of stages in the manufacturing process. In particular, it is desired to reduce the number of polymerisations in autoclaves, eliminate the traditional operations of trimming or cutting the edges and the subsequent final phase of application of the cladding of glass fibre onto the cut edges.

Another object of the invention is to reduce the amount of footing necessary for the traditional cutting of the edges, as well as the cost of labour for the final application of the glass fibre cladding.

A further object of the invention is to produce monolithic structural elements having a greater structural strength than those obtained by means of the traditional fabrication process discussed above.

These and other objects and advantages which will be better understood hereinafter are achieved according to the present invention by a method as defined in the annexed claims.

One preferred, but non-limitative, embodiment of the invention will now be described making reference to the attached drawings, in which:

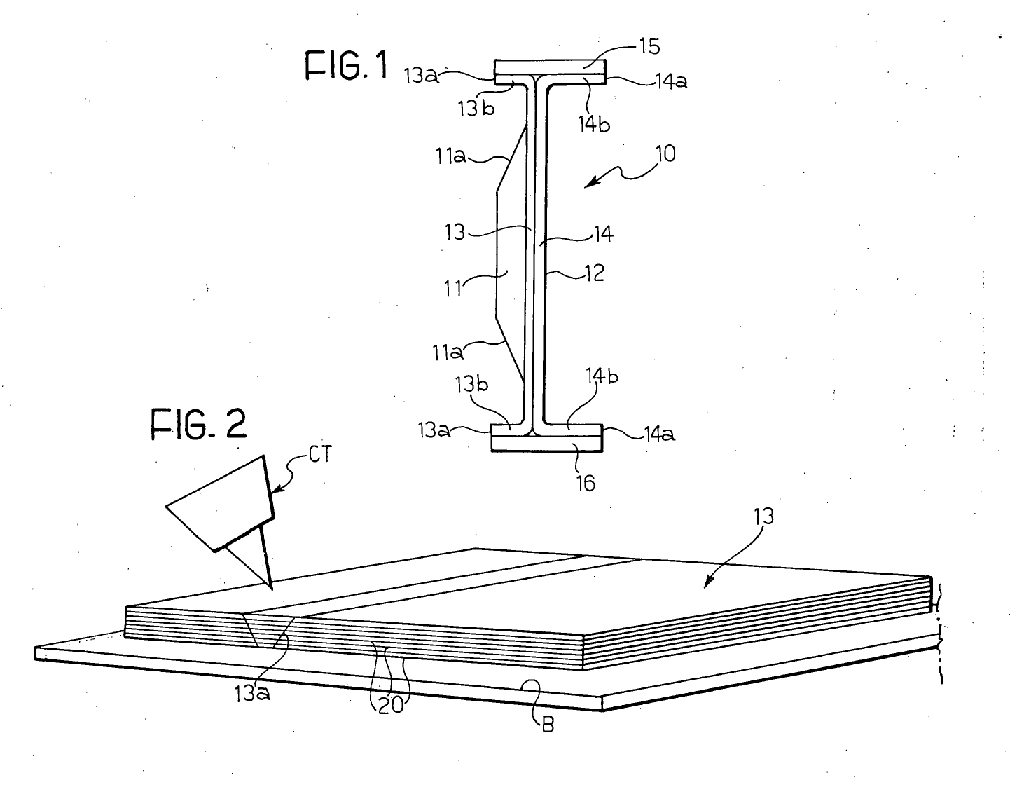

FIG. 1 is a transverse sectional view which schematically illustrates the main components of a beam formed according to the invention;

FIG. 2 is a perspective view which schematically shows a cutting stage of the method of the invention;

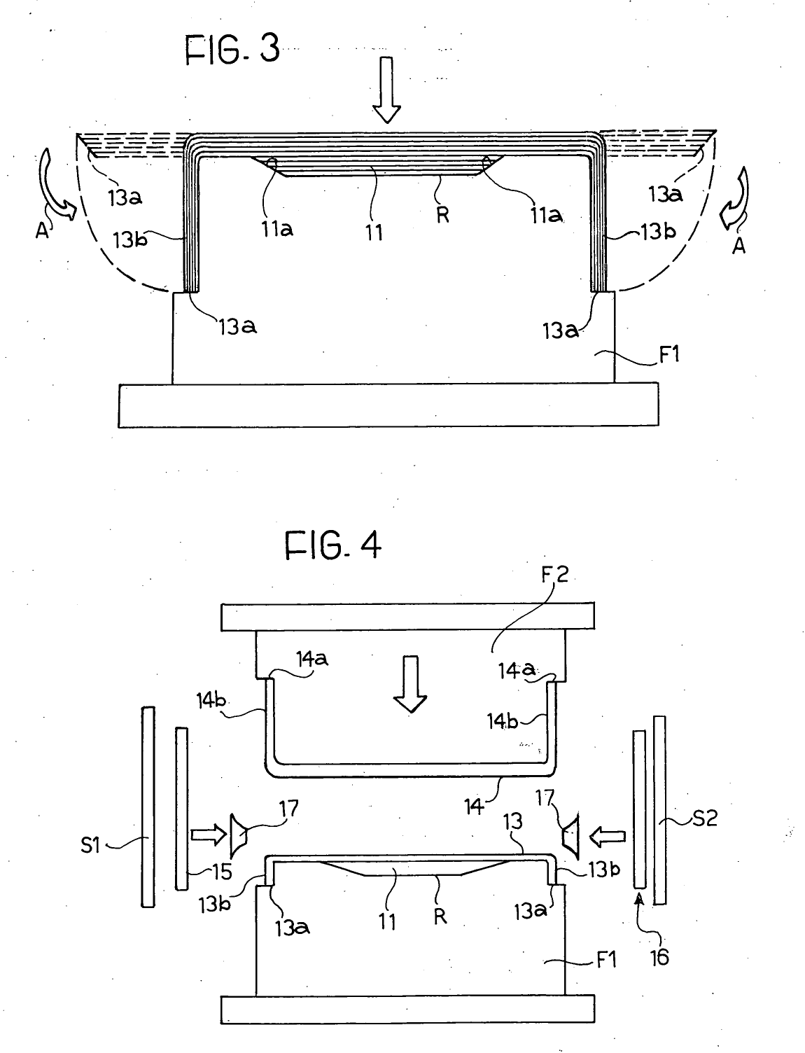

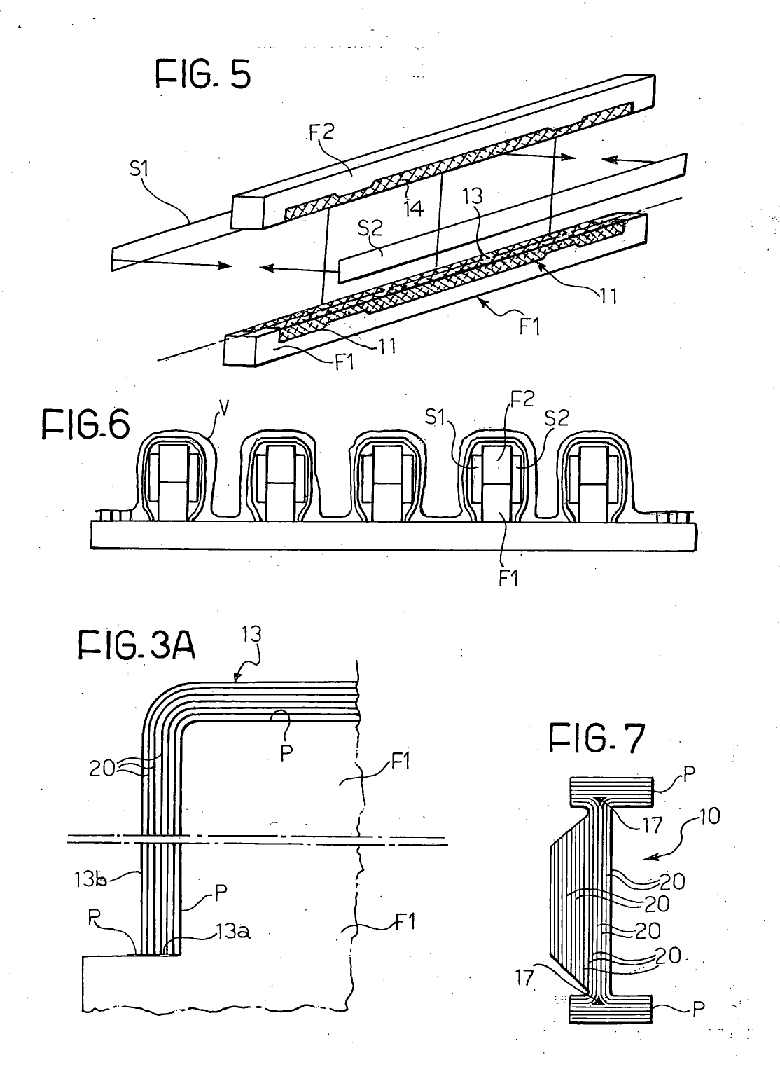

FIGS. 3, 4 and 5 schematically illustrate shaping and assembling stages of the blanks of which the beam of FIG. 1 is to be composed;

FIG. 3A is an enlarged view of a detail of FIG. 3;

FIG. 6 illustrates a subsequent curing stage in an autoclave with a vacuum bag applied on a series of shaping tools of the type illustrated in FIGS. 4 and 5; and

FIG. 7 is a transverse sectional view of the finished beam.

In the example illustrated and described herein refers to the manufacturing of a beam as schematically illustrated in section in FIG. 1, having a substantially I or H or “double T”) section with local reinforcements or thickenings on one or both faces of the web, intended to support the so-called “upper deck” of an aircraft. Clearly, the reference to this possible field of application must not in any way be interpreted as limiting the scope of the patent.

With reference to FIG. 1, the reference numeral 10 generally indicates a double T beam with local reinforcements 11 on one of the faces of the web 12. These reinforcements (only one of which is visible in section in FIG. 1) are spaced longitudinally along the web as is known to those skilled in the art. The beam 10 is obtained from the union of various blank elements which are then cured in a single curing phase in an autoclave as described above. These blank elements comprise: two C-shape elements 13, 14 counterposed with respect to one another which together constitute the main part of the web and part of the flanges, two flat elements 15, 16 which complete the top and bottom parts of the flanges, and a series of reinforcements 11 (so-called “doublers”) or local thickenings on one of the two faces of the web.

With reference to FIG. 2, each of the partly worked elements 11-16 is prepared by making a flat lamination of unidirectional carbon fibre mats 20 pre-impregnated with epoxy resin (also called “carbo-resin matting”). The carbo-resin mats 20 are superimposed on a support surface B thus obtaining partly worked products defined here as “flat laminates”, each constituted by a stratified succession of mats 20. The flat laminates are then cut along their edges by means of a cutting machine, preferably a numerically controlled machine, which controls the movements of a cutting tool CT which is suitably inclinable to cut the edges of the flat laminates along a predetermined cut angle with respect to the plane in which the mats 20 lie.

An important characteristic of the method of the invention is that some of the edges of the flat laminates are cut at a cut angle different from 90° with respect to the plane in which the mats 20 lie. In particular the oblique edges 11a of the reinforcement 11 and some edges 13a, 14a of the flat laminates intended to constitute the “C” shape elements 13, 14 are cut obliquely. Thanks to this arrangement, at the end of the subsequent hot shaping phase (FIG. 3) in which the terminal parts 13b, 14b of these elements are bent at a right angle, the edges of these stratifications 20 together define a flat surface 13a, 14a orientated perpendicularly of the plane of the bent parts 13b, 14b. These edge surfaces 13a, 14a do not need any further trimming or cutting operations.

As illustrated in FIG. 3, the reinforcements 11 and the flat blank 13 are placed in succession on a shaping tool F1 the shape of which they will copy during the subsequent hot shaping and curing stages. The reinforcements 11 are received in a recess R of the tool F1. By means of a hot shaping operation (known per se and therefore not described in detail here) the flat blank 13 is folded as indicated by the arrows A and constrained to copy the profile of the tool F1.

With reference to FIG. 4, similar steps to those described above (flat lamination, cutting of inclined edges and hot shaping on a second tool F2) are performed on a second blank 14 constituting the second “C” section element intended to be positioned face to face with and joined to the first blank 13. Then the two flat blank elements 15, 16 are applied for completion of the flanges, inserting two resin strips 17 into the connector zones.

The shaping tool is then closed by lateral counterplates S1, S2, placed in a vacuum bag V (FIG. 6) and subjected to a curing cycle in an autoclave by applying temperature and pressure in a manner known per se.

It is to be noted that between the shaping tools F1, F2, S1, S2 and the blanks to be cured there is preliminarily interposed a sheet of glass fibre P (FIG. 3A) which, at the end of the polymerisation phase (FIG. 7) constitutes an outer cladding layer which satisfies the so-called FST (Flammability-Smoke-Toxicity) requirements prescribed in the aeronautical environment.

The final result of the process, as schematically illustrated in FIG. 7, is a composite beam 10 of carbon fibre with an external cladding layer of glass fibre matting P which continuously clads all the external surfaces of the beam, including its edges.

As will be appreciated, the method according to the invention envisages a single curing cycle (rather than two) and produces a monolithic structure with a more intimate and stronger binding of the reinforcements formed integrally with the web. The traditional phases of application of adhesive to join the reinforcements to the web are eliminated as are the operations of trimming the edges and the associated tools, and the final operations for applying the glass fibre cladding to the cut edges is no longer required. It will be appreciated, moreover, that the outer glass fibre cladding layer P is a continuous layer and intimately bound to the surfaces of the beam with consequent reduction in the risks of triggering corrosion.

It is intended that the invention shall not be limited to the embodiment described and illustrated here, which is to be considered as an example of performance of the process; the invention is on the other hand capable of associated modifications in shape, dimensions and constructional details of the beams. For example, the invention can equally be used to produce structural elements with sections of the most varied forms (“C”, “L”, “T”, “J” etc) with or without lateral reinforcements on the web.

What is claimed is:

1. A method for manufacturing a beam of composite material based on carbon fibre for the construction of aircraft, of the type comprising layers of carbon fibre matting pre-impregnated with resin, the method comprising the steps of:
a) superimposing onto a support plane a plurality of mats of carbon fibre pre-impregnated with resin so as to obtain at least one first flat laminate;
b) cutting at least one edge of the flat laminate at a pre-determined cut angle different from 90° with respect to the support plane of the mat;
c) placing the flat laminate onto a shaping tool;
d) hot shaping the laminate so as to copy the shape of the forming tool, bending at least one part of the laminate deliminated by the said cut edge in such a way that the said cut edge, at the end of the bending step, defines a surface orientated substantially perpendicularly with respect to the said bent part;
e) applying temperature and pressure in such a way as to polymerise the resin contained in the matting layers.

2. The method of claim 1, further including the steps of:
prearranging at least one second laminate according to step a) and optionally according to steps b) and c) and d);
placing the second laminate in contact with the first laminate on a shaping tool before the said step e);
performing step e) to simultaneously polymerise the resin contained in the layers of mat of the first and the second laminate.

3. The method of claim 2, in which the first laminate is a longitudinally elongate element able to constitute at least one part of a web of a beam, and the second laminate is a reinforcement applied onto one face of the first laminate to locally thicken the said web.

4. The method of claim 3, including the steps of:
c1) positioning the second laminate in a recess of the shaping tool before positioning the first laminate onto the same shaping tool in the said step c).

5. The method of claim 3, in which the said step c1) is preceded by the steps of:
b1) cutting at least one edge of the second flat reinforcement laminate at a predetermined cut angle different from 90° with respect to the support plane of the matting of the second laminate.

6. The method of claim 1, further including the steps of:
placing a glass fibre mat between the shaping tool and the laminate to be polymerised in such a way as to cover the surfaces of the laminate intended to constitute the outer surfaces of the finished beam, also cladding the said cut edges.
